(19) United States
(12) Patent Application Publication
(10) Pub. No.: US 2005/0097300 A1
(43) Pub. Date: May 5, 2005

(54) Processing system and method including a dedicated collective offload engine providing collective processing in a distributed computing environment

(75) Inventors: Kevin J. Gildea, Bloomington, NY (US); Rama K. Govindaraju, Hopewell Junction, NY (US); Peter H. Hochschild, New York, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/697,859

(22) Filed: Oct. 30, 2003

(51) Int. Cl. G06F 15/00

(52) U.S. Cl. 712/11

(57) ABSTRACT

A dedicated collective offload engine provides collective processing of data from processing nodes in a distributed computing environment. The dedicated collective offload engine and the processing nodes are coupled to a switch fabric. A result is produced by the collective offload engine based on the collective processing of the data, and is forwarded to at least one processing node. Collective processing is facilitated by communication among a plurality of dedicated collective offload engines via the switch fabric or via a private channel disposed between the collective offload engines.

### FIELD OF THE INVENTION

This invention relates in general to a distributed computing environment, and in particular, to a processing system and method including a dedicated collective offload engine providing collective processing of distributed data received from processing nodes in a distributed computing environment.

### BACKGROUND OF THE INVENTION

Collective processing is the collective combination and dissemination of information across processes in a distributed computing environment. Performance of conventional collective processes on large distributed computing environments is a key determinant of system scalability.

Typically, implementation of collective processing includes using a software tree approach, where message passing facilities are used to form a virtual tree of processes. One drawback of this approach is the serialization of delays at each stage of the tree. These delays are additive in the overall overhead associated with the collective processing. Furthermore, this software tree approach results in a theoretical logarithmic scaling latency of the overall collective processing versus system size. Due to interference from daemons, interrupts and other background activity, cross traffic, and the unsynchronized nature of independent operating system images and their dispatch cycles, measured values of scaling latency are usually significantly worse than theoretical values.

Scaling latency has been minimally improved by enhancement attempts that include tuning communication protocol stacks and provision of certain schedulers. Techniques such as “daemon squashing” to synchronize daemon activity are likely to bring practical results in line with theoretical ones, but the cost of multiple traversals of the software tree-based protocol stack remain.

Accordingly, a need remains for a novel collective processing approach that, for example, mitigates the large latency associated with a software tree approach.

### SUMMARY OF THE INVENTION

The shortcomings of the prior art are overcome and additional advantages are provided through the provision of a processing system comprising a dedicated collective offload engine. The dedicated collective offload engine is, for example, coupled to a switch fabric of a distributed computing environment having multiple processing nodes also coupled to the switch fabric. Further, the dedicated collective offload engine, for instance, provides collective processing of data from at least some processing nodes of the multiple processing nodes and produces a result based thereon. The result is forwarded to at least one processing node of the multiple processing nodes.

A method, computer program products, and a data structure corresponding to the above-summarized system are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of one embodiment of a distributed computing environment incorporating and using one or more aspects of the present invention;

FIG. 2 is a block diagram of one embodiment of a dedicated collective offload engine, in accordance with one or more aspects of the present invention; and

FIG. 3 depicts one embodiment of a packet data structure to be sent by a processing node and used in collective processing by a dedicated collective offload engine, in accordance with one or more aspects of the present invention.

### BEST MODE FOR CARRYING OUT THE INVENTION

In accordance with an aspect of the present invention, a facility is provided which enables high performance collective processing of data in a distributed computing environment. In particular, collective processing is performed by a dedicated collective offload engine in communication with processing nodes of the distributed computing environment across a switch fabric.

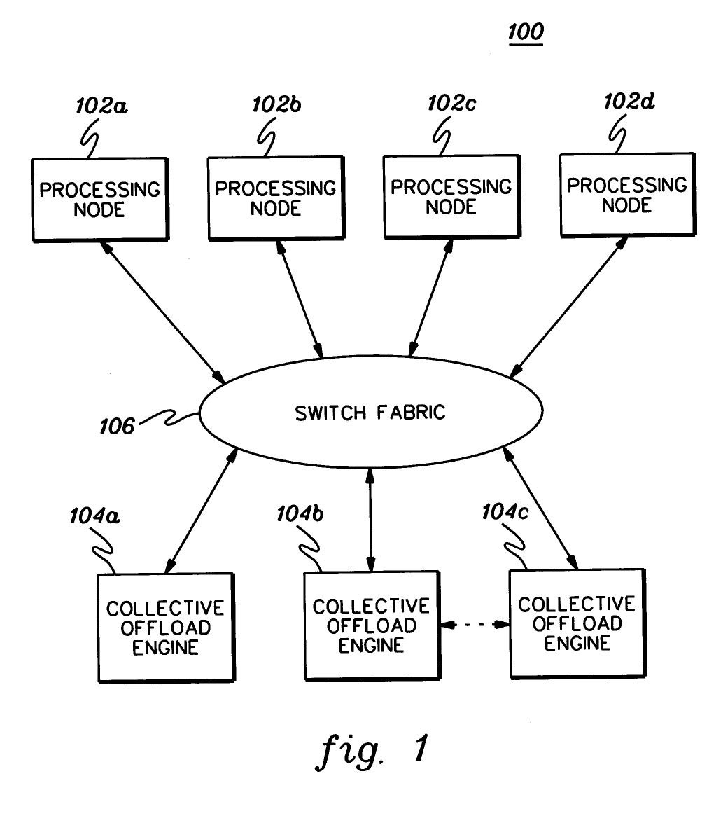

One embodiment of a distributed computing environment, generally denoted 100, incorporating and using one or more aspects of the present invention is depicted in FIG. 1. As shown, distributed computing environment 100 includes, for example, multiple processing nodes 102a-102d coupled to a switch fabric 106 and at least one dedicated collective offload engine 104a-104c also coupled to switch fabric 106. Dedicated collective offload engines 104a-104c are, for example, coupled to switch fabric 106 in a manner similar to the coupling of processing nodes 102a-102d to switch fabric 106. Communications are transmitted via switch fabric 106 between, for instance, two processing nodes 102a and 102b, a processing node and a dedicated collective offload engine 102a and 104a, or two (or more) dedicated collective offload engines 104a and 104b. Examples of switch fabric 106 include an InfiniBand switch and a Federation switch, both offered by International Business Machines Corporation of Armonk, N.Y. Multiple processing nodes 102 are, for example, servers, such as RS/6000 or eServer pSeries servers offered by International Business Machines Corporation. Multiple processing nodes 102 may be homogeneous or heterogeneous processing nodes.

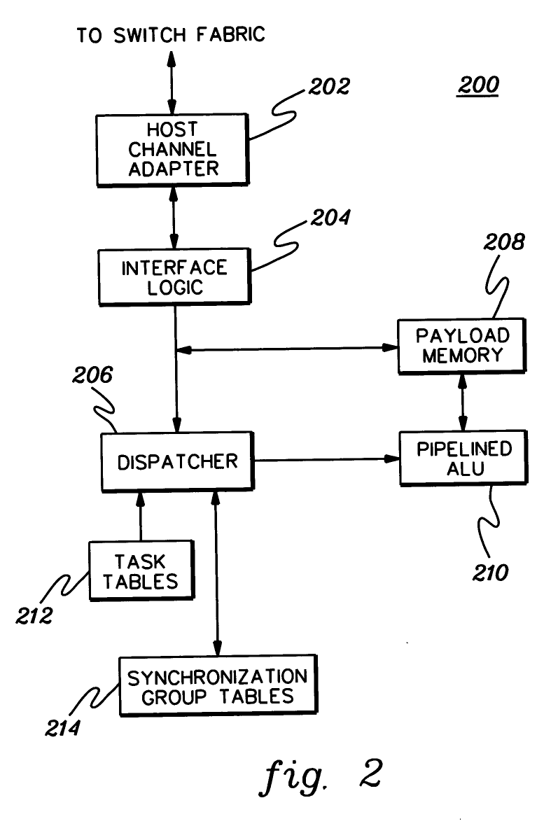

In accordance with an aspect of the present invention, dedicated collective offload engine 104a is, for example, a dedicated hardware device built from, for instance, field programmable gate arrays (FPGAs). Collective offload engine 104a is a specialized device dedicated to providing collective processing of data from at least some of the processing nodes 102a-102d. For example, collective offload engine 104a might receive data contributions from certain participating processing nodes of the multiple processing nodes connected to switch fabric 106. For example, processing nodes 102a-102c might send data to be globally summed. Instead of using the conventional software tree approach whereby the data contributions are distributively summed at various levels of a tree across the network, the collective operation of global summing is offloaded to dedicated collective offload engine 104a. At the dedicated collective offload engine, collective processing is applied to the data contributions of the processing nodes to produce a global sum, and this result is then forwarded to one or more processing nodes, such as the data contributing nodes. Other collective operations, including standard Message Passing Interface (MPI) collective operations could be substituted for the global summing operation in this example. Operation of a dedicated collective offload engine is described in more detail below relative to FIG. 2.

The capacity of collective processing required in a distributed computing environment depends on contributed data payload lengths and system size, which is indicated by, for example, the number of processing nodes. To accommodate various collective processing capacities, various modifications can be made to the computing environment described above. One approach is to use cascaded multiple dedicated collective offload engines 104a-104c that are coupled to switch fabric 106 and in communication with each other via the switch fabric. A second approach employs multiple dedicated collective offload engines attached to switch fabric 106 with a private channel between them, as depicted by the dashed bi-directional arrow between dedicated collective offload engines 104b and 104c. In this private channel approach, one dedicated collective offload engine 104b could combine, for example, results from odd numbered processing nodes while dedicated collective offload engine 104c might combine results from even numbered processing nodes. Using their private channel, the two results are then combined and known to each dedicated collective offload engine. Each collective offload engine could then broadcast the combined result to interested processing nodes. A third approach provides a multi-ported dedicated collective offload engine. Other approaches may include various combinations of the three approaches described above.

One embodiment of a dedicated collective offload engine, in accordance with an aspect of the present invention, is depicted in FIG. 2 and generally denoted 200. Within dedicated collective offload engine 200, an adapter, such as a host channel adapter 202, is coupled to and facilitates communication across switch fabric 106 (FIG. 1) using a link protocol. Host channel adapter 202 is, for example, a GigE, Federation or SP Switch2 adapter. Interface logic 204 provides an interface between host channel adapter 202 and a dispatcher 206 and a payload memory 208. Dispatcher 206 is implemented in, for example, FPGAs, and is the entity that executes protocol to process packets received from and sent to processing nodes 102a-102d. Payload memory 208 receives and stores data contributions from processing nodes 102a-102d participating in a collective operation. These data contributions are included in, for instance, vector operands of collective operations used in collective processing of the data contributions. A pipelined arithmetic logic unit (ALU) 210 retrieves and performs the collective processing of the data contributions. ALU 210 might operate at, for instance, approximately 250 Mflop/s (mega floating point operations per second). Dispatcher 206 controls collective processing of the data contributions by, for example, directing ALU 210 to the payload memory storage locations that contain particular data contributions required for a collective operation. In the global sum example described above, payload memory 208 would receive data contributed by participating processing nodes and dispatcher 206 would track where that data is located and direct ALU 210 to perform the summing of the data.

Collective processing control by dispatcher 206 also extends to tracking both process task information associated with the participating processing nodes and synchronization group information. Process task identification information is stored in task tables 212 and provides addressing information for packets directed to processing nodes 102 by dispatcher 206. Synchronization group identification information is stored in synchronization group tables 214 and allows dispatcher 206 to determine, for instance, when data contributions from the processing nodes in the synchronization group are received. Moreover, the identification information in synchronization group tables 214 allows dispatcher 206 to identify which synchronization group is associated with a particular data contribution, even when multiple synchronization groups correspond to the process task that generates the data contribution. This identification facilitates collective processing of data that is associated with, for example, a single synchronization group.

Synchronization groups are groups of processing nodes which are used to perform, for example, sub-computations in “divide and conquer” algorithms. Sub-computations are completed within each synchronization group and dispatcher 206 would recognize when the result from each sub-computation has been received by payload memory 208. Once all sub-computation results have been received, dispatcher 206 provides the storage locations of the sub-computation results to ALU 210 and directs the ALU to perform collective processing using the sub-computation results. This collective processing produces a final result, which is then forwarded to the interested participating processing nodes. One example of a synchronization group is an MPI communicator or communicating group, which identifies a subset of processes (or tasks) of a parallel job to which a collective operation can be directed without affecting processes outside the identified subset.

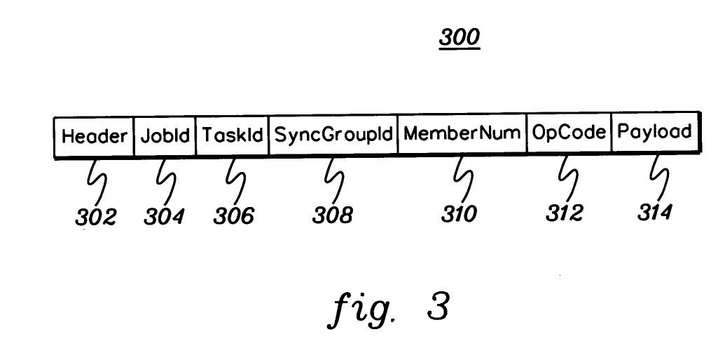

FIG. 3 depicts one example of a data structure for a data packet 300 sent from a processing node participating in collective processing by a dedicated collective offload engine. This exemplary packet includes a standard packet header field 302, the contents of which depend on the switching technology implemented. With Ethernet switching, for instance, an Internet Protocol header would be used. A JobId field 304 identifies the currently running parallel application or job to which packet 300 pertains. A TaskId field 306 identifies the task within the identified job that sent packet 300. SynchGroupId field 308 identifies the synchronization group of processing nodes to which the operation identified by packet 300 pertains. MemberNum field 310 indicates which member of the synchronization group sent packet 300. OpCode field 312 specifies the type of collective operation to be performed. Examples of types of collective operations include floating point maximum, floating point sum, and integer sum. Payload field 314 includes the data contributed by the identified processing node for the specified collective operation. As noted, data in payload 314 is received and stored in payload memory 208 and retrieved by ALU 210 (FIG. 2) under the direction of dispatcher 206. ALU 210 performs the collective operation specified in OpCode 312 using the data in payload 314.

The following performance analysis example illustrates the performance advantage of a processing system based on a dedicated collective offload engine (COE), as described herein, when used for a barrier operation in a distributed computing environment using an available interconnect switch fabric.

Assumptions used in the performance analysis include:
Interconnect latency for MPI point-to-point=5 μs
Interconnect link bandwidth=2 GB/s
Barrier packet size including headers=64 bytes
Interconnect fabric latency=0.8 μs
One COE serves approximately 32 nodes; 32 COEs serve a 1024-node system.

The steps to execute a barrier operation using COEs are:
1. Each processing node sends a 64-byte packet to its COE (MPI send side overhead) in less than 2.5 μs.
2. 32 processing nodes×64 bytes each=2 KB arrives at the COE in 1 μs.
3. COE pipeline latency is less than 2 μs.
4. COE sends 2 KB of reply data to the 32 processing nodes in 1 μs.
5. Processing nodes receive replies (MPI receive side overhead) in less than 2.5 μs.

Thus, the total time for the 32 processing nodes is approximately 9 μs. For a 1024-processing node system, the COEs can be cascaded into two stages resulting in cascading overhead of approximately 5 μs. Therefore, the total time for a barrier operation in a 1024-processing node system is approximately 14 μs.

In contrast, the theoretical performance for a 1024-node barrier operation using a conventional software tree approach is approximately 2 log₂ 1024×5 μs=100 μs, assuming no overhead and delays due to interference from daemons, interrupts and other operating system activity. In this expression, the factor of 2 indicates that the software tree is traversed in both up and down directions, and log₂ 1024 is the height of the tree. The factor of 5 μs is the latency of a single point-to-point message.

Thus, in this case, the dedicated collective offload engine improves collective processing performance approximately by a factor of 7 versus the theoretical, optimistic estimate for the software tree approach.

Although the above example is based on an MPI collective operation, those skilled in the art will note that the dedicated collective offload engine is applicable to other operations to achieve enhanced system performance. For example, distributed lock management operations associated with distributed databases and distributed file systems can be implemented in a COE-based processing system where distributed locks are stored in the dedicated collective offload engine. As another example, in a cluster/parallel file system, global atomic operations and global system level locks can be implemented using the collective offload engine. Global synchronization primitives in, for instance, the Unified Parallel C programming language can also be stored in the collective offload engine. Further, a collective offload engine could be used as a mechanism to scatter an executable file or replicate data used by a parallel job to multiple processing nodes associated with the parallel job.

Those skilled in the art will note from the above discussion that one or more aspects of the present invention advantageously include a dedicated collective offload engine that provides collective processing of data from processing nodes in a distributed computing environment. This enables, for example, an approach that accelerates collective processing and promotes deterministic performance in a manner that enhances scalability of distributed computer systems. Thus, these beneficial characteristics of the dedicated collective offload engine decrease the average time required to perform collective operations and reduce random fluctuations in those time periods. Moreover, because the dedicated collective offload engine(s) is positioned apart from mainline communication paths between processing nodes via the fabric switch, it does not interfere with the performance or development of these mainline paths. Further, the dedicated collective offload engine is extensible because it can, for example, be easily adapted to various types of switch fabrics.

The present invention can be included in an article of manufacture (e.g., one or more computer program products) having, for instance, computer usable media. The media has embodied therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine, embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A processing system comprising:
a dedicated collective offload engine coupled to a switch fabric of a distributed computing environment having multiple processing nodes also coupled to the switch fabric; and
wherein the dedicated collective offload engine provides collective processing of data from at least some processing nodes of the multiple processing nodes and produces a result based thereon, said result being forwarded to at least one processing node of the multiple processing nodes.

2. The processing system of claim 1, wherein the dedicated collective offload engine is implemented as a hardware device coupled to the switch fabric.

3. The processing system of claim 1, wherein the dedicated collective offload engine comprises:
a payload memory configured to receive and store the data from the at least some processing nodes of the multiple processing nodes; and
an arithmetic logic unit (ALU) coupled to the payload memory, wherein said ALU is configured to retrieve and perform the collective processing of data stored in the payload memory.

4. The processing system of claim 3, wherein the dedicated collective offload engine further comprises:
a dispatcher coupled to the ALU and in communication with the at least some processing nodes of the multiple processing nodes via the switch fabric, said dispatcher configured to control the collective processing of the data from the at least some processing nodes of the multiple processing nodes and the sharing of the result based thereon.

5. The processing system of claim 4, wherein the dedicated collective offload engine further comprises:
at least one task table coupled to the dispatcher, wherein the at least one task table is configured to store task identification information related to the at least some processing nodes of the multiple processing nodes; and
at least one synchronization group table coupled to the dispatcher, wherein the at least one synchronization group table is configured to store identification information related to one or more groups of the at least some processing nodes of the multiple processing nodes.

6. The processing system of claim 4, wherein the dedicated collective offload engine further comprises:
an adapter coupled to the switch fabric, wherein said adapter is configured to communicate with the switch fabric using a link protocol; and
interface logic coupled to the adapter, the payload memory and the dispatcher, wherein the interface logic facilitates communication between said adapter and said payload memory and between said adapter and said dispatcher.

7. The processing system of claim 1, wherein the processing system further comprises a plurality of dedicated collective offload engines in communication with one another via the switch fabric, wherein said communication facilitates the collective processing of data from the at least some processing nodes of the multiple processing nodes and the producing of the result based thereon.

8. The processing system of claim 1, wherein the processing system further comprises a plurality of dedicated collective offload engines in communication with one another via a channel disposed therebetween, said channel being independent of the switch fabric, and wherein said communication facilitates the collective processing of data from the at least some processing nodes of the multiple processing nodes and the producing of the result based thereon.

9. The processing system of claim 1, wherein the collective processing provided by the dedicated collective offload engine includes execution of at least one collective operation for the at least some processing nodes of the multiple processing nodes without using a software tree.

10. The processing system of claim 1, wherein the collective processing provided by the dedicated collective offload engine includes managing at least one distributed lock associated with at least one of a distributed database and a distributed file system.

11. A system for processing, said system comprising:
means for providing, by a dedicated collective offload engine coupled to a switch fabric in a distributed computing environment, collective processing of data from at least some processing nodes of multiple processing nodes of the distributed computing environment;
means for producing, by the dedicated collective offload engine, a result based on said collective processing; and
means for forwarding said result to at least one processing node of the multiple processing nodes.

12. A method of processing comprising:
providing, by a dedicated collective offload engine coupled to a switch fabric in a distributed computing environment, collective processing of data from at least some processing nodes of multiple processing nodes of the distributed computing environment;
producing, by the dedicated collective offload engine, a result based on said collective processing; and
forwarding said result to at least one processing node of the multiple processing nodes.

13. The method of claim 12, wherein the dedicated collective offload engine is implemented as a hardware device coupled to the switch fabric.

14. The method of claim 12, further comprising:
receiving and storing, at a payload memory, the data from the at least some processing nodes of the multiple processing nodes, wherein said payload memory is a component of the dedicated collective offload engine; and
retrieving and performing, at an arithmetic logic unit (ALU), the collective processing of data stored in the payload memory, wherein said ALU is a component of the dedicated collective offload engine and is coupled to the payload memory.

15. The method of claim 14, further comprising:
controlling the collective processing of the data from the at least some processing nodes of the multiple processing nodes, wherein said controlling is performed by a dispatcher of the dedicated collective offload engine coupled to the ALU, and in communication with the at least some processing nodes of the multiple processing nodes via the switch fabric; and
controlling, by the dispatcher, the sharing of the result with the at least one processing node of the multiple processing nodes.

16. The method of claim 15, further comprising:
storing, in at least one task table coupled to the dispatcher, task identification information related to the at least some processing nodes of the multiple processing nodes, wherein said at least one task table is a component of the dedicated collective offload engine; and
storing, in at least one synchronization group table coupled to the dispatcher, identification information related to one or more groups of the at least some processing nodes of the multiple processing nodes, wherein said at least one synchronization group table is a component of the dedicated collective offload engine.

17. The method of claim 15, further comprising:
communicating, via an adapter, across the switch fabric using a link protocol, wherein said adapter is coupled to the switch fabric and is a component of the dedicated collective offload engine; and
facilitating, by interface logic, communication between said adapter and said payload memory and between said adapter and said dispatcher, wherein said interface logic is a component of the dedicated collective offload engine.

18. The method of claim 12, further comprising:
communicating among a plurality of dedicated collective offload engines via the switch fabric, wherein said communicating facilitates the collective processing of data from the at least some processing nodes of the multiple processing nodes and the producing of the result based thereon.

19. The method of claim 12, further comprising:
communicating among a plurality of dedicated collective offload engines via a channel disposed therebetween, said channel being independent of the switch fabric, wherein said communicating facilitates the collective processing of data from the at least some processing nodes of the multiple processing nodes and the producing of the result based thereon.

20. The method of claim 12, wherein said providing collective processing includes executing at least one collective operation for the at least some processing nodes of the multiple processing nodes without using a software tree.

21. At least one program storage device readable by a machine, tangibly embodying at least one program of instructions executable by the machine to perform a method of processing comprising:
providing, by a dedicated collective offload engine coupled to a switch fabric in a distributed computing environment, collective processing of data from at least some processing nodes of multiple processing nodes of the distributed computing environment;
producing, by the dedicated collective offload engine, a result based on said collective processing; and
sharing said result with at least one processing node of the multiple processing nodes.

22. The at least one program storage device of claim 21, wherein the dedicated collective offload engine is implemented as a hardware device coupled to the switch fabric.

23. The at least one program storage device of claim 21, said method further comprising:
receiving and storing, at a payload memory, the data from the at least some processing nodes of the multiple processing nodes, wherein said payload memory is a component of the dedicated collective offload engine; and
retrieving and performing, at an arithmetic logic unit (ALU), the collective processing of data stored in the payload memory, wherein said ALU is a component of the dedicated collective offload engine and is coupled to the payload memory.

24. The at least one program storage device of claim 23, said method further comprising:
controlling the collective processing of the data from the at least some processing nodes of the multiple processing nodes, wherein said controlling is performed by a dispatcher of the dedicated collective offload engine coupled to the ALU, and in communication with the at least some processing nodes of the multiple processing nodes via the switch fabric; and
controlling, by the dispatcher, the sharing of the result with the at least one processing node of the multiple processing nodes.

25. The at least one program storage device of claim 24, said method further comprising:
storing, in at least one task table coupled to the dispatcher, task identification information related to the at least some processing nodes of the multiple processing nodes, wherein said at least one task table is a component of the dedicated collective offload engine; and
storing, in at least one synchronization group table coupled to the dispatcher, identification information related to one or more groups of the at least some processing nodes of the multiple processing nodes, wherein said at least one synchronization group table is a component of the dedicated collective offload engine.

26. The at least one program storage device of claim 24, said method further comprising:
communicating, via an adapter, across the switch fabric using a link protocol, wherein said adapter is coupled to the switch fabric and is a component of the dedicated collective offload engine; and
facilitating, by interface logic, communication between said adapter and said payload memory and between said adapter and said dispatcher, wherein said interface logic is a component of the dedicated collective offload engine.

27. The at least one program storage device of claim 21, said method further comprising:
communicating among a plurality of dedicated collective offload engines via the switch fabric, wherein said communicating facilitates the collective processing of data from the at least some processing nodes of the multiple processing nodes and the producing of the result based thereon.

28. The at least one program storage device of claim 21, said method further comprising:
communicating among a plurality of dedicated collective offload engines via a channel disposed therebetween, said channel being independent of the switch fabric, wherein said communicating facilitates the collective processing of data from the at least some processing nodes of the multiple processing nodes and the producing of the result based thereon.

29. The at least one program storage device of claim 21, wherein said providing collective processing includes executing at least one collective operation for the at least some processing nodes of the multiple processing nodes without using a software tree.

30. A data structure facilitating collective processing, said data structure comprising:
a packet to be sent from a processing node, of multiple processing nodes coupled to a switch fabric in a distributed computing environment, to a dedicated collective offload engine also coupled to the switch fabric, said packet comprising:
a first field including an identifier of a collective operation to be executed by said dedicated collective offload engine; and
a second field including a payload, wherein said payload comprises data from said processing node to be collectively processed by said dedicated collective offload engine based on the collective operation.
